(19) United States
(12) Patent Application Publication
(10) Pub. No.: US 2026/0299160 A1
(43) Pub. Date: Oct. 1, 2026

(54) SYSTEMS AND METHODS FOR DOWNHOLE LITHIUM SENSING

(71) Applicant: SAUDI ARABIAN OIL COMPANY, Dhahran (SA)

(72) Inventors: Klemens Katterbauer, Dhahran (SA); Abdallah A. AlShehri, Dhahran (SA); Abdulaziz S. Al-Qasim, Dammam (SA); Ali Abdallah AlYousef, Dhahran (SA)

(73) Assignee: SAUDI ARABIAN OIL COMPANY, Dhahran (SA)

(21) Appl. No.: 19/097,612

(22) Filed: Apr. 1, 2025

(51) Int. Cl. G01V 9/00; E21B 43/29; E21B 47/12; E21B 49/08; H04W 4/38

(52) U.S. Cl. CPC G01V 9/00; E21B 47/12; E21B 49/08; H04W 4/38; E21B 43/29

(57) ABSTRACT

Described is a method for downhole lithium sensing. The method includes deploying ionophore-based sensor units into a subsurface reservoir. Wireless communication is established between the ionophore-based sensor units and a computing unit. For each ionophore-based sensor unit, a sample of reservoir brine from the subsurface reservoir is collected. A local concentration value of ionic lithium in the sample is determined and transmitted to a computing unit which determines a total concentration value of ionic lithium from the local concentration values. In response to the total concentration value exceeding a predetermined threshold, lithium extraction operations are initiated.

### BACKGROUND

Lithium and its compounds are widely used in manufactured glass, ceramics, greases, batteries, refrigerants, chemical reagents and other industries. Lithium demand is expected to grow continuously and dramatically in the coming years as different types of lithium batteries are promising candidates for powering electric and hybrid vehicles. Lithium batteries include such as a lithium-ion battery, lithium-sulfur battery, and lithium-air battery.

A subsurface environment is an attractive resource for recovering valuable minerals such as lithium. While the concentration of ionic lithium is quite low (~0.17 ppm) in seawater, brine in a subsurface environment, such as a subsurface reservoir, includes ionic lithium in concentrations as high as 10²-10³ ppm. Therefore, downhole reservoir sensing plays a critical role in enhancing lithium extraction from these subsurface reservoirs.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for downhole lithium sensing. The system comprises a plurality of ionophore-based sensor units disposed within a first subsurface reservoir. Each ionophore-based sensor unit comprises a housing in which a lithium ionophore sensor, a wireless communication unit, and a microprocessor connected with the lithium ionophore sensor are disposed. The system further comprises a computing unit located outside the first subsurface reservoir, which is in wireless communication with the plurality of ionophore-based sensor units. Each ionophore-based sensor unit is configured to collect a sample of reservoir brine from the first subsurface reservoir, determine a local concentration value of ionic lithium in the sample, and transmit the local concentration value to the computing unit. The computing unit is configured to estimate a total concentration value of ionic lithium in the first subsurface reservoir from the local concentration values.

In another aspect, each ionophore-based sensor unit is configured to wirelessly communicate with one or more other ionophore-based sensor units.

In another aspect, for each ionophore-based sensor, the wireless communication unit is configured to transmit the local concentration value to the computing unit.

In another aspect, the system comprises at least one base station in wireless communication with the plurality of ionophore-based sensor units, wherein the at least one base station is located in the first subsurface reservoir.

In another aspect, for each ionophore-based sensor, the wireless communication unit is configured to transmit the local concentration value to the at least one base station.

In another aspect, the at least one base station is disposed in an injection well, a producing well, or both an injection well and a producing well.

In another aspect, the lithium ionophore is selected from the group consisting of a dibenzo-16-crown-5 ether derivative, a bis(crown ether)s derivative and combinations thereof.

In another aspect, each ionophore-based sensor unit comprises a propulsion unit powered by a motor disposed within the housing and configured to propel the ionophore-based sensor unit.

In another aspect, the propulsion unit comprises at least one of a propeller, one or more fins, or a shape-memory alloy based thruster.

In another aspect, each ionophore-based sensor unit comprises a position sensor configured to determine a position of the ionophore-based sensor unit within the first subsurface reservoir.

In one aspect, embodiments disclosed herein relate to a method for downhole lithium sensing. The method comprises deploying a plurality of ionophore-based sensor units into a first subsurface reservoir and establishing wireless communication between the plurality of ionophore-based sensor units and a computing unit. For each ionophore-based sensor unit, the method comprises collecting a sample of reservoir brine from the first subsurface reservoir, determining a local concentration value of ionic lithium in the sample, and transmitting the local concentration value to the computing unit. A total concentration value of ionic lithium is determined from the local concentration values by the computing unit. In response to the total concentration value exceeding a predetermined threshold, lithium extraction operations are initiated.

In another aspect, deploying the plurality of ionophore-based sensor units comprises pumping a liquid comprising the plurality of ionophore-based sensor units into the first subsurface reservoir.

In another aspect, the local concentration values obtained using the plurality of ionophore-based sensor units are transmitted to the one or more base stations. The local concentration values are received at the one or more base stations and transmitted to the computing unit, wherein the computing is located outside the first subsurface reservoir, and wherein the computing unit is wirelessly connected to the one or more base stations.

In another aspect, at least one ionophore-based sensor unit is propelled within the first subsurface reservoir via a propulsion unit connected with the at least one ionophore-based sensor unit.

In another aspect, a position for each of the plurality of ionophore-based sensor units within the first subsurface reservoir is determined, and the local concentration values obtained from the plurality of ionophore-based sensor units are mapped to the positions within the first subsurface reservoir.

In another aspect, lithium concentration data for a second subsurface reservoir is predicted using a machine learning algorithm based on the local concentration values obtained from the plurality of ionophore-based sensor units.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a well site in accordance with one or more embodiments.

FIG. 2 illustrates a reservoir with injection and production wells, lithium sensor units, and base stations in accordance with one or more embodiments.

FIG. 3 illustrates a lithium sensor unit in accordance with one or more embodiments.

FIG. 4 illustrates a flow diagram of a method for downhole lithium sensing in accordance with one or more embodiments.

FIG. 5 illustrates a computing unit in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

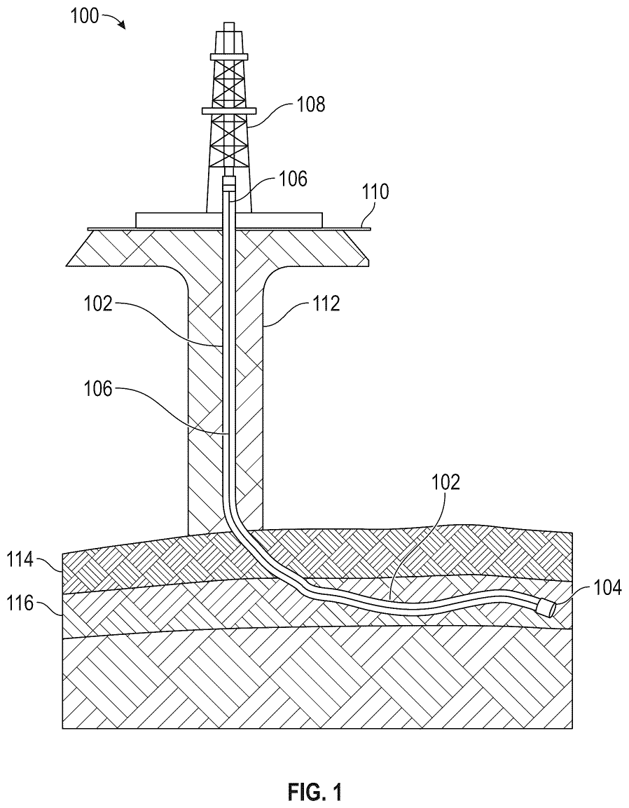

In the following description of FIGS. 1-5, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein relate to systems and methods for real-time, downhole lithium sensing using a plurality of ion-specific sensor units. Brine from subsurface environments, such as hydrocarbon reservoirs, includes higher concentrations of lithium than seawater. In one or more embodiments, the system comprises a plurality of ionophore-based sensor units disposed within a reservoir and a computing unit in electrical communication with the plurality of ionophore-based sensor units. Each ionophore-based sensor unit is configured to determine a local concentration value of ionic lithium from a sample of reservoir brine sample and transmit the local concentration value to the computing unit.

FIG. 1 shows an exemplary well site 100 in accordance with one or more embodiments. Specifically, FIG. 1 shows a well 102 that may be drilled by a drill bit 104 attached by a drillstring 106 to a drill rig 108 located on the surface of the earth 110. The borehole corresponds to the uncased portion of the well 102. The borehole trajectory is the path in three-dimensional space that the well is drilled through the subsurface. The borehole of the well 102 may traverse a plurality of overburden layers 112 and one or more cap-rock layers 114 to an aquifer or hydrocarbon reservoir 116. One or more wells 102 may be drilled to produce hydrocarbons, to re-inject produced water or gas back into an aquifer or hydrocarbon reservoir 116, or to monitor for escaping gases or fluids.

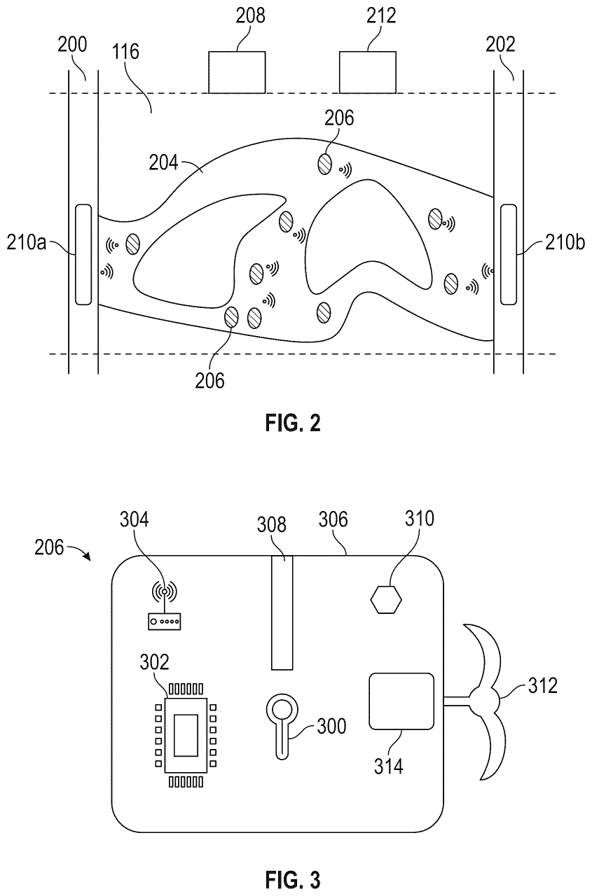

According to one more embodiments, FIG. 2 depicts a hydrocarbon reservoir 116 that may be evaluated as a potential source for lithium recovery. In this embodiment, an injection well 200 and a producing well 202 have been drilled into the hydrocarbon reservoir 116. As fluids (e.g., wastewater, produced brine) are injected into the reservoir 116 via the injection well 200, reservoir brine 204 collects underground between the injection well 200 and the producing well 202. Generally, reservoir brine 204 is stored in the subsurface area of the reservoir 116 until it is displaced by the pressure caused by produced hydrocarbons flowing towards the producing well 202. The reservoir brine 204 provides a potential resource for lithium recovery. According to one or more embodiments, the concentration of lithium in the reservoir brine 204 may be measured by placing lithium-specific sensors in situ into the reservoir 116.

As shown in FIG. 2, a plurality of sensor units 206 may be deployed into the reservoir 116 and distributed within the reservoir brine 204 for obtaining measurements in a local environment surrounding each sensor unit 206. In one or more embodiments, wireless communication between the sensor units 206 and a computing unit 208 is established. The cooperation and sharing of data between the sensor units 206 may be accomplished via distributed processing algorithms for collaborative sensing to achieve accurate lithium concentration mapping.

Additionally, the sensor units 206 may communicate wirelessly with one or more base stations 210a, 210b. In one or more embodiments, Zigbee, a low-power, low-data-rate, and close proximity wireless ad hoc network, is used for wireless communication in the system described herein. Wireless communication may also be facilitated through Radio Frequency Identification (RFID), Near Field Communication (NFC), acoustic waves, light pulses, low-energy Bluetooth, low-energy wireless, low-energy radio protocols, LTE-A, and WiFi-Direct technologies, or other wireless methods, without departing from the scope of this disclosure. Repeaters and/or relay nodes may also be positioned in or near the reservoir for longer-range transmissions. Communication between the sensor units 206 and the surface may also be wired, if feasible.

Connectivity between the sensor units 206 may be established using an Internet of Things (IoT) protocol, for example, to initiate communication/transmission of sensed data, including location coordinates, amongst the sensor units 206, until the sensed data reaches the base stations 210a, 210b. Each base station 210a, 210b may include a large antenna connected to an aboveground gateway, where the gateway transmits data to the computing unit 208, where information may be recorded. In the example shown in FIG. 2, there is a first base station 210a disposed within the injection well 200 and a second base station 210b disposed within the producing well 202. As can be appreciated by one skilled in the art, the system described herein is not limited to the particular arrangement depicted in FIG. 2. Accordingly, the system may include a single base station or three or more base stations disposed within the reservoir at any suitable location(s) without departing from the scope of this disclosure.

In one or more embodiments, due to the connectivity between the sensor units 206, the computing unit 208, and the one or more base stations 210a, 210b, sensor data may be received and communicated in real-time, enabling efficient decision making. Non-limiting examples of decisions that may be made include, but are not limited to, causing the sensor units 206 to move to another area of the reservoir for data collection and causing the sensor units 206 to obtain additional measurements in a current position to confirm the quality of the data. In one or more embodiments, an operator or analyst initiates lithium extraction operations at the reservoir based on the lithium concentrations recorded. Additionally, an extraction rate or extraction method may be adjusted according to lithium concentration values in order to maximize yield and minimize costs. In areas of the reservoir determined to have higher lithium concentrations, a resource allocation decision may be made to deploy additional sensors and/or extraction equipment.

Following lithium extraction operations, the environmental impact may be assessed and appropriate adjustments to the reservoir site may be made to mitigate any negative effects. For instance, land disturbances in a reservoir used for lithium extraction may be minimized to prevent habitat loss. Based on the determined lithium concentrations for a given reservoir, the profitability of extraction in view of current lithium prices and operation costs may be determined. In one or more embodiments, lithium and/or operational data related to a given reservoir may be evaluated to predict when equipment maintenance is needed, preventing unexpected downtime.

The system described herein may further comprise a control unit 212 to control actions/operations performed by the sensor units 206. The movement of the sensor units 206 may be controlled, random, or a combination of both random and controlled. Controlled movement by the control unit 212 allows efficient coverage of the reservoir 116 with the ability to focus sensing operations in particular areas of interest where high concentrations of lithium are predicted. For instance, the sensor units 206 may be remotely controlled by the control unit 212 to travel to different zones or regions of the reservoir 116 to collect measurements throughout the reservoir 116. Random movement of the sensor units 206 may permit exploration of unpredictable areas, thereby reducing the possibility of excluding areas of the reservoir 116 where high concentrations of lithium is less predictable.

In one or more embodiments, the control unit 212 is configured to be in electrical communication with the sensor units 206, the base stations 210a, 210b, the computing unit 208, or any combination thereof. The control unit 212 may include hardware and/or software for managing operations performed by the sensor units 206. For example, the control unit 212 may include one or more programmable logic controllers (PLCs) that include hardware and/or software with functionality to control one or more processes performed by the sensor units 206. In particular, a programmable logic controller may be a ruggedized computer system with functionality to withstand vibrations, extreme temperatures, wet conditions, and/or dusty conditions, for example, around a reservoir. The system may be further configured to be scalable and adaptable. In one or more embodiments, modular hardware and software architectures allow for the addition of more sensor units, as needed, as well as the ability to adapt to changing conditions or new requirements.

Furthermore, the control unit 212 may include functionality to present raw and/or processed data, such as sensor unit data, temperature sensor data, flow sensor data, position data, or pressure sensor data, among others. For example, presenting data may be accomplished through various presenting methods. Specifically, data states may be presented through a user interface provided by the computing unit 208. The user interface may include a graphic user interface (GUI) that displays information on a display device, such as a computer monitor or a touchscreen on a handheld computer device. The GUI may include various GUI widgets that organize what data is shown as well as how data is presented to a user.

The GUI may present data directly to the user, e.g., data presented as actual data values through text, or rendered by the computing unit 208 into a visual representation of the data, such as through visualizing a system model. For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type. In one or more embodiments, the GUI is used by operators/analysts to monitor sensor data, adjust sensor unit settings, and make informed decisions based on real-time data. The control unit 212 may also be configured to manage other components of the system, such as the base stations 210a, 210b, extraction machinery (e.g., pumps, valves), safety systems (e.g., emergency shut-offs), and data loggers.

FIG. 3 depicts a sensor unit 206 according to one or more embodiments of the present disclosure. Each sensor unit 206 may have its own independent software, power harvesting ability, and processing ability. In the embodiment shown in FIG. 3, the sensor unit 206 comprises an ion-selective sensor 300, a microprocessor 302, and a wireless communication unit 304. The components of the sensor unit 206 may be disposed within a rugged housing 306 that protects the components from the harsh conditions of a reservoir. For instance, due to extreme temperatures and pressures that may be encountered in geophysical formations, the housing 306 may comprise titanium alloys (e.g., Ti-6Al-4V) and/or fiber-reinforced polymers (e.g., carbon fiber reinforced polymer), which are corrosion-resistant, thermally stable, lightweight, and durable. In one or more embodiments, the sensor unit 206 is coated with a layer of ceramic or diamond-like carbon to enhance durability. Additionally, the sensor unit 206 may be a field programmable gate array (colloquially referred to as FPGA) sensor unit which functions in the harsh downhole environment. In one or more embodiments, the sensors units 206 are designed to withstand high salinity, temperature fluctuations, and mechanical stresses through adaptive sampling strategies that adjust sensor unit 206 operation based on changing reservoir conditions.

The ion-selective sensor 300 is configured to gather information concerning ionic lithium in the subsurface environment according to one or more embodiments. The ion-selective sensor 300 may receive ionic lithium through a sampling unit 308. The sampling unit 308 may be configured to obtain a sample from the subsurface environment and send the sample to the ion-selective sensor 300. The sampling unit 308 may obtain a sample via a dedicated port or diffusion through a semi-permeable membrane, allowing ionic lithium to flow from the surrounding formation fluids in the subsurface environment, such as brine, into the sensor unit 206. In one or more embodiments, the sensor data collected by each sensor unit 206 is a local concentration value of ionic lithium in an obtained sample of reservoir brine. The local concentration value of ionic lithium may be transmitted to the computing unit 208 from the sensor unit 206 directly. Alternatively, the local concentration value of ionic lithium may be transmitted to the base stations 210a, 210b, which then transmit the values to the computing unit 208.

The ion-selective sensor 300 may include an ion-selective electrode, such as a lithium ionophore. The ion-selective electrode may further include a polymeric membrane doped with the lithium ionophore. Different types of the lithium ionophore may be used provided that the lithium ionophore has affinities for lithium-ion. Non-limiting examples of the lithium ionophore may include crown ethers type, cryptands type, lariat ethers type, neutral carriers type like valinomycin analogues and combinations thereof. Examples of crown ether type may include, but are not limited to, dibenzo-16-crown-5 ether derivatives, bis(crown ether)s derivatives and combinations thereof. The ion-selective sensor 300 may further include a reference electrode for improving accuracy. For instance, the reference electrode may be Ag/AgCl or a calomel electrode.

In one or more embodiments, the ion-selective sensor 300 includes a signal processing component which processes the analysis of digital signals to improve the accuracy of the value of the concentration of ionic lithium. The signal processing unit may incorporate elements of model predictive control and Kalman filtering which enable fusing of the ionic lithium concentration data obtained by the ion-selective sensor 300, correcting for noise and errors, and generating a compressive picture of the information regarding ionic lithium in the subsurface environment. Imaging techniques may be applied to interpret the gathered value and infer valuable insights about ionic lithium in the subsurface environment. Examples of the imaging techniques may include seismic inversion, electrical resistivity tomography (ERT), induced polarization (IP) and combinations thereof.

The microprocessor 302 is connected to the ion-selective sensor 300 in electrical communication in accordance with one or more embodiments. The microprocessor 302 may be configured to receive the ionic lithium data and determine the value of the concentration of ionic lithium in the sample obtained. In one or more embodiments, the microprocessor 302 is a low-power and rugged microprocessor, such as is used in industrial control systems or aerospace applications. Alternatively, the microprocessor 302 may be an artificial intelligence (AI) microprocessor. The microprocessor 302 may receive, as input, the concentration of lithium in a sample and other types of data. For example, the microprocessor 302 may continuously receive measured parameters, such as pressure data, temperature data, optical measurements, electrical fluid measurements, and the like, and integrate the data with the sample point data to estimate an overall lithium concentration for the reservoir 116. The microprocessor 302 may utilize a deep learning framework, such as a long short-term memory (LSTM) network long short-term memory network (LSTM) framework, to analyze the data. A LSTM network is a type of recurrent neural network. The microprocessor 302 may implement a machine learning engine, or model, comprising one or more of an artificial neural network (ANN), a support vector machine, a decision tree, a regression tree (RT), a random forest, an extreme learning machine (ELM), Type I and Type II Fuzzy Logic (T1FL/T2FL), a multivariate linear regression, etc. The machine learning engine may be tuned to match the complexity or otherwise of training data to ensure optimal model performance using adjustable learning parameters, referred to as tuning parameters. The same calibration subset may be used repeatedly while searching for the optimal parameters. The microprocessor 302 may be further configured to control the sampling unit 308 such that samples of the reservoir brine are collected in periodic intervals (e.g., every 15 minutes). Additionally, the microprocessor 302 may be configured to automatically analyze and interpret the data as the data is being measured by the various sensors/meters in real-time. Alternatively, the collected samples may be sent to a lab for analysis.

In one or more embodiments, machine learning algorithms are utilized to analyze sensor data, predict lithium concentrations, and optimize sensor unit deployment and operation. Models may be trained on historical data to make informed decisions regarding the sensor units 206, such as deployment strategies and determining how many sensor units 206 are needed in a given reservoir. Furthermore, data from multiple sensor units 206 may be integrated using statistical methods or machine learning algorithms. Techniques to address data redundancy may also be implemented. Data collected by the sensor units 206 may be secured from unauthorized access, particularly in sensitive or regulated environments, via any suitable data security and privacy techniques and software. For instance, one or more of encryption, firewalls, access controls, data loss prevention (DLP), security audits, data minimization, and/or data anonymization may be implemented.

To sustain operation of the sensor units 206 over extended periods of time, the sensor units 206 may utilize compact batteries (e.g., lithium-thionyl chloride cells) or rechargeable lithium-ion batteries. In addition, energy-harvesting components, such as piezoelectric generators or thermoelectric converters, may be incorporated into the sensor units 206. Supercapacitors or thin-film batteries may also be utilized. In one or more embodiments, the sensor units 206 are configured to prolong battery life, especially in remote locations, by implementing power management strategies, such as scheduling data transmissions. Moreover, diagnostic processes may be utilized to detect faulty sensor readings and recovery processes may be used to recover from faults, such as sensor failures. For instance, the sensor units 206 may be configured with self-diagnostic capabilities for automated responses to malfunctions.

The wireless communication unit 304 may be connected to the microprocessor 302 in electrical communication. The wireless communication unit 304 may be configured to transmit the value of the concentration of ionic lithium in the obtained sample to the computing unit 208 located outside the reservoir 116. The wireless communication unit 304 may be further configured to transmit the value of the concentration of ionic lithium to the control unit 212. The electrical communication may be low-latency wireless communication. The low-latency wireless communication enables prompt and efficient transmission of critical real-time data, allowing for timely decision-making and optimizing operations. Real-time data processing of sensor data may enable immediate detection of anomalies and trends as well as the ability to adjust sensor unit settings and/or deployment strategies, as necessary.

Other types of data may also be obtained using the sensor units 206. Referring to FIG. 3, each sensor unit 206 may further comprise a position sensor 310. Non-limiting examples of position sensors 310 include potentiometric position sensors, inductive position sensors, eddy current-based position sensors, capacitive position sensors, magneto strictive position sensors, hall effect-based magnetic position sensors, fiber-optic position sensors, optical position sensors, and ultrasonic position sensors. The position sensor 310 may be used to obtain position data related to the sensor unit 206, which may then be transmitted to one or more of the base stations 210a, 210b, the computing unit 208, and/or other sensor units 206 in the reservoir. According to one or more embodiments, the position data along with the local concentration values of ionic lithium may be used to map lithium concentration values to particular locations within the reservoir. The captured sensor data, including position and lithium concentration data, may be analyzed and mapped to create a detailed representation of lithium concentrations across the reservoir. Over a period of time, the movement, or spread, of lithium in the reservoir 116 may be estimated based on the positions of the sensor units 206 and the real-time sensor measurements being recorded.

In one or more embodiments, each sensor unit 206 has a propulsion mechanism comprising a propulsion unit 312 powered by, for instance, a motor 314 disposed within the housing 306 of the sensor unit 206. The sensor units 206 may navigate the reservoir with the use of acoustic signals, magnet fields, or optical communications. Alternatively, the motor 314 may be configured to be remotely controlled by the control unit 212. According to one or more embodiments, the propulsion unit 312 is configured to propel the sensor unit 206 through the reservoir brine 204 to different locations in the reservoir 116 for obtaining measurements. The propulsion unit 312 may be a propeller, one or more fins, a shape-memory alloy based thruster, or any other type of propulsion unit capable of propelling the sensor unit 206 through liquid. Like the housing 306, the propulsion unit 312 may be comprised of a durable material capable of withstanding reservoir conditions.

In addition to position data, the sensor units 206 may be configured to collect other types of sensor and environmental data. For example, sensor and environmental data may include, but is not limited to temperature data, pressure data, flow data, and fluid phase data. Collected pressure and temperature data may be correlated with lithium concentration values at different positions of the reservoir. The recorded data may be processed by the computing unit 208, for example in a Hadoop framework, and then collected in a database, such as a Non-SQL database. In one or more embodiments, sensor data is transmitted, processed, and stored using edge computing technology for real-time performance, reduced latency, and reduced bandwidth usage.

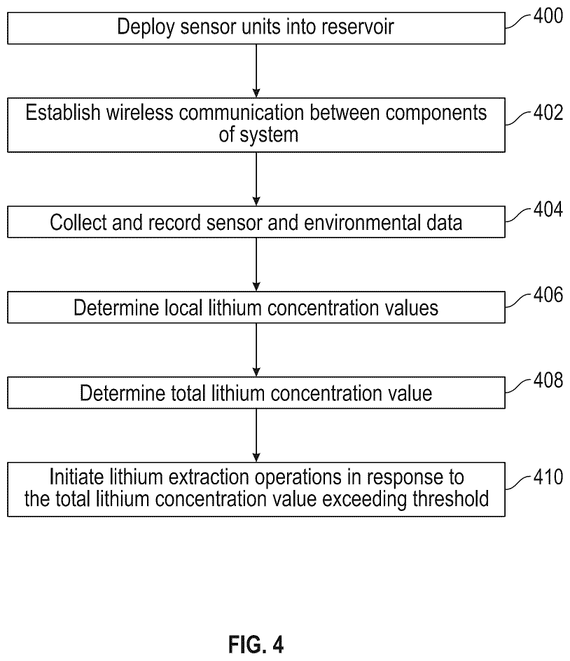

FIG. 4 illustrates a flowchart for the method of using the sensor units described herein to estimate lithium concentrations in reservoir brine. It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts. In Step 400, a plurality of sensor units are deployed in a reservoir. Deployment may include, for example, fluid carrying the sensor units to desired locations where each sensor unit positions itself, dropping the sensor units into the reservoir free form, or allowing the sensor units to mobilize themselves and traverse the reservoir until a desired location is reached. Additional modes of deployment may include the use of remotely operated vehicles (ROVs), autonomous underwater vehicles (UAVs), ground vehicles, aircraft, infrastructure (e.g., pipes, equipment) at the reservoir site, and/or cluster or network deployment. The ROVs, UAVs, and ground vehicles may be utilized to deploy the sensor units at precise locations within the reservoir. Aircraft may be implemented for sensor unit deployment when coverage over large and/or inaccessible areas of the reservoir is desired. The use of the reservoir infrastructure for distribution of the sensor units may reduce costs and disruption to the reservoir site. Cluster or network deployment of sensor units in groups may increase data precision and mapping capabilities within the reservoir.

Upon deployment, or shortly thereafter, in Step 402, wireless communication is established among the sensor units, between the sensor units and the one or more base stations (if included) computing unit, and control unit (if included), and between the one or more base stations and the computing unit. Communication between the various components may be done sequentially in a particular order, or simultaneously.

In Step 404, the deployed sensor units collect and record environmental and sensor data. Environmental and sensor data may include measurements of lithium concentration, pressure, temperature, and/or a location in the reservoir or a particular zone or region in the reservoir, as described in detail above. In Step 406, a local lithium concentration value is determined by each individual sensor unit. The local lithium concentration values are combined to estimate a total lithium concentration value in Step 408. In one or more embodiments, the lithium concentration values may be sampled locally at each sensor unit in periodic intervals, and the total of the lithium concentration values is used to estimate the amount of lithium in the reservoir.

The method further comprises, in Step 410, initiating lithium extraction operations in response to the total concentration value exceeding a predetermined threshold. Typically, lithium is measured in parts per million (ppm). In one or more embodiments, a useful concentration of lithium ranges from about 200 ppm to any concentration above 800 ppm, such as 1,000 ppm. Within this range, 200 ppm to 400 ppm may be defined as a low concentration, 400 ppm to 800 ppm may be defined as a medium concentration, and any concentration above 800 ppm may be defined as a high concentration. Thus, a predetermined threshold value for initiating the performance of lithium extraction operations may be selected from any value within the range of 200 ppm to 800 ppm and above depending on the particular desired application.

In one or more embodiments, in response to the total concentration value exceeding a predetermined threshold, the brine is pumped out from the subsurface environment and lithium is extracted from the brine. Lithium extraction may be conducted, but is not limited to, mixing the brine with an organic solvent including a lithium ionophore and extracting lithium from the organic solvent. Examples of the lithium ionophore may include, but are not limited to, dibenzo-16-crown-5 ether derivatives, bis(crown ether)s derivatives and combinations thereof. The concentration of the lithium ionophore in the organic solvent may be 1 mM or more and 10 mM or less. Examples of organic solvents may include, but are not limited to, dichloromethane, toluene and combinations thereof. Lithium may be extracted from the organic solvent including the lithium ionophore and ionic lithium. Additionally, lithium may be recovered from a reservoir via lithium absorption-desorption on a metal oxide followed by refining or evaporation and concentration of lithium.

In addition to determining whether a particular reservoir is a suitable candidate for lithium extraction, the sensor data and environmental data obtained from a “first” reservoir may be used to train a machine learning algorithm based on historical data to make predictions regarding the lithium concentration values in a “second” (or additional) reservoir having similar geological characteristics (e.g., location, temperature, porosity, size, permeability, pressure). Non-limiting examples of machine learning algorithms that may be used for data prediction include linear regression, decision trees, support vector machines (SVMs), and LSTM models.

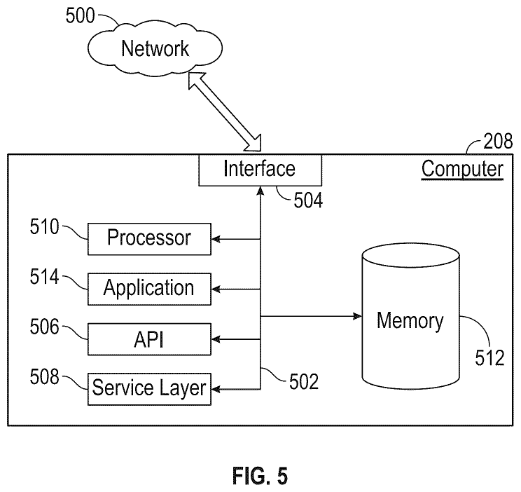

FIG. 5 depicts a block diagram of the computing unit 208 used to provide computational functionalities associated with described algorithms, methods, functions, processes, flows, and procedures as described in this disclosure, according to one or more embodiments. Specifically, the computing unit 208 may be configured to receive the values of the concentrations of ionic lithium from the sensor units and/or the one or more base stations. The computing unit 208 may transmit the respective values to the control unit 210.

The illustrated computing unit 208 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computing unit 208 may include an input device, such as a keypad, keyboard, touch screen, or other device that can accept user information, and an output device that conveys information associated with the operation of the computing unit 208, including digital data, visual, or audio information (or a combination of information), or a GUI.

The computing unit 208 may serve in a role as a client, network component, a server, a database or other persistency, or any other component (or a combination of roles) of a computer system for performing the subject matter described in the instant disclosure. The illustrated computing unit 208 may be communicably coupled with a network 500. In some implementations, one or more components of the computing unit 208 is configured to operate within environments, including cloud-computing-based, local, global, or other environment (or a combination of environments).

At a high level, the computing unit 208 is an electronic computing device operable to receive, transmit, process, store, or manage data and information associated with the described subject matter. According to some implementations, the computing unit 208 may also include or be communicably coupled with an application server, e-mail server, web server, caching server, streaming data server, business intelligence (BI) server, or other server (or a combination of servers).

In accordance with one or more embodiments, the computing unit 208 may receive requests over network 500 from a client application (for example, executing on another computer) and responding to the received requests by processing the said requests in an appropriate software application. In addition, requests may also be sent to the computing unit 208 from internal users (for example, from a command console or by other appropriate access method), external or third-parties, other automated applications, as well as any other appropriate entities, individuals, systems, or computers.

In one or more embodiments, each of the components of the computing unit 208 may communicate using a system bus 502. In some implementations, any or all of the components of the computing unit 208, both hardware or software (or a combination of hardware and software), may interface with each other or the interface 504 (or a combination of both) over the system bus 502 using an application programming interface (API) 506 or a service layer 508 (or a combination of the API 506 and service layer 508). The API 506 may include specifications for routines, data structures, and object classes. The API 506 may be either computer-language independent or dependent and refer to a complete interface, a single function, or even a set of APIs. The service layer 508 provides software services to the computing unit 208 or other components (whether or not illustrated) that are communicably coupled to the computing unit 208. The functionality of the computing unit 208 may be accessible for all service consumers using this service layer. Software services, such as those provided by the service layer 508, provide reusable, defined business functionalities through a defined interface. For example, the interface may be software written in JAVA, C++, or other suitable language providing data in extensible markup language (XML) format or another suitable format. While illustrated as an integrated component of the computing unit 208, alternative implementations may illustrate the API 506 or the service layer 508 as stand-alone components in relation to other components of the computing unit 208 or other components (whether or not illustrated) that are communicably coupled to the computing unit 208. Moreover, any or all parts of the API 506 or the service layer 508 may be implemented as child or sub-modules of another software module, enterprise application, or hardware module without departing from the scope of this disclosure.

In one or more embodiments, the computing unit 208 includes an interface 504. Although illustrated as a single interface 504 in FIG. 5, two or more interfaces 504 may be used according to particular needs, desires, or particular implementations of the computing unit 208. The interface 504 is used by the computing unit 208 for communicating with other systems in a distributed environment that are connected to the network 500 to facilitate decentralized processing and data analysis. Generally, the interface 504 includes logic encoded in software or hardware (or a combination of software and hardware) and operable to communicate with the network 500. More specifically, the interface 504 may include software supporting one or more communication protocols associated with communications such that the network 500 or interface's hardware is operable to communicate physical signals within and outside of the illustrated computing unit 208.

In one or more embodiments, the computing unit 208 includes at least one computer processor 510. Although illustrated as a single computer processor 510 in FIG. 5, two or more processors may be used according to particular needs, desires, or particular implementations of the computing unit 208. Generally, the computer processor 510 executes instructions and manipulates data to perform the operations of the computing unit 208 and any algorithms, methods, functions, processes, flows, and procedures as described in the instant disclosure.

In accordance with one or more embodiments, the computing unit 208 also includes a memory 512 that holds data for the computing unit 208 or other components (or a combination of both) that can be connected to the network 500. For example, memory 512 can be a database storing data consistent with this disclosure. Although illustrated as a single memory 512 in FIG. 5, two or more memories may be used according to particular needs, desires, or particular implementations of the computing unit 208 and the described functionality. While memory 512 is illustrated as an integral component of the computing unit 208, in alternative implementations, memory 512 can be external to the computing unit 208.

In accordance with one or more embodiments, the application 514 is an algorithmic software engine providing functionality according to particular needs, desires, or particular implementations of the computing unit 208, particularly with respect to functionality described in this disclosure. For example, the application 514 can serve as one or more components, modules, applications, etc. Further, although illustrated as a single application 514, the application 514 may be implemented as multiple applications 514 on the computing unit 208. In addition, although illustrated as integral to the computing unit 208, in alternative implementations, the application 514 can be external to the computing unit 208.

There may be any number of computing unit 208 associated with, or external to, a computer system containing the computing unit 208, wherein each computer communicates over network 500. Further, the term “client,” “user,” and other appropriate terminology may be used interchangeably as appropriate without departing from the scope of this disclosure. Moreover, this disclosure contemplates that many users may use one computer, or that one user may use multiple computers.

Embodiments of the present disclosure may provide at least one of the following advantages. The system and method described herein enables real-time lithium detection in reservoir brine due to the deployment of multiple sensor units configured to wirelessly communicate with each other as well as components located inside and outside the reservoir. The utilization of multiple sensor units allows for the simultaneous capturing of sensor data from multiple locations in the reservoir. Additionally, with the use of position sensors, the sensor units may obtain both position data and lithium concentration data in order to map the specific lithium concentrations to different locations within the reservoir.

Several factors are significant to the proper implementation of the sensor units. In one or more embodiments, the sensor units are regularly calibrated and validated against standards to ensure accurate data collection. The sensor units need to be strategically positioned within the reservoir for optimal data collection with a focus on areas with varying lithium concentrations within the reservoir. Proper placement of the sensor units may also allow effective monitoring of gradients and changes in lithium concentrations over time.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system for downhole lithium sensing, comprising:
a plurality of ionophore-based sensor units disposed within a first subsurface reservoir, each ionophore-based sensor unit comprising a housing in which a lithium ionophore sensor, a wireless communication unit, and a microprocessor connected with the lithium ionophore sensor are disposed; and
a computing unit located outside the first subsurface reservoir, the computing unit in wireless communication with the plurality of ionophore-based sensor units,
wherein each ionophore-based sensor unit is configured to:
collect a sample of reservoir brine from the first subsurface reservoir;
determine a local concentration value of ionic lithium in the sample; and
transmit the local concentration value to the computing unit, and
wherein the computing unit is configured to estimate a total concentration value of ionic lithium in the first subsurface reservoir from the local concentration values.

2. The system of claim 1, wherein each ionophore-based sensor unit is configured to wirelessly communicate with one or more other ionophore-based sensor units.

3. The system of claim 1, wherein for each ionophore-based sensor, the wireless communication unit is configured to transmit the local concentration value to the computing unit.

4. The system of claim 1, comprising at least one base station in wireless communication with the plurality of ionophore-based sensor units, wherein the at least one base station is located in the first subsurface reservoir.

5. The system of claim 4, wherein for each ionophore-based sensor, the wireless communication unit is configured to transmit the local concentration value to the at least one base station.

6. The system of claim 4, wherein the at least one base station is disposed in an injection well, a producing well, or both an injection well and a producing well.

7. The system of claim 1, wherein the lithium ionophore is selected from the group consisting of a dibenzo-16-crown-5 ether derivative, a bis(crown ether)s derivative and combinations thereof.

8. The system of claim 1, wherein each ionophore-based sensor unit comprises a propulsion unit powered by a motor disposed within the housing and configured to propel the ionophore-based sensor unit.

9. The system of claim 8, wherein the propulsion unit comprises at least one of a propeller, one or more fins, or a shape-memory alloy based thruster.

10. The system of claim 1, wherein each ionophore-based sensor unit comprises a position sensor configured to determine a position of the ionophore-based sensor unit within the first subsurface reservoir.

11. A method for downhole lithium sensing, comprising:
deploying a plurality of ionophore-based sensor units into a first subsurface reservoir;
establishing wireless communication between the plurality of ionophore-based sensor units and a computing unit;
for each ionophore-based sensor unit:
collecting a sample of reservoir brine from the first subsurface reservoir;
determining a local concentration value of ionic lithium in the sample; and
transmitting the local concentration value to the computing unit;
determining, by the computing unit, a total concentration value of ionic lithium from the local concentration values; and
in response to the total concentration value exceeding a predetermined threshold, initiating lithium extraction operations.

12. The method of claim 11, wherein deploying the plurality of ionophore-based sensor units comprises pumping a liquid comprising the plurality of ionophore-based sensor units into the first subsurface reservoir.

13. The method of claim 11, comprising:
transmitting, to one or more base stations, the local concentration values obtained using the plurality of ionophore-based sensor units;
receiving, at the one or more base stations, the local concentration values obtained using the plurality of ionophore-based sensor units; and
transmitting the local concentration values from the one or more base stations to the computing unit, wherein the computing is located outside the first subsurface reservoir, and wherein the computing unit is wirelessly connected to the one or more base stations.

14. The method of claim 11, comprising propelling at least one ionophore-based sensor unit within the first subsurface reservoir via a propulsion unit connected with the at least one ionophore-based sensor unit.

15. The method of claim 11, comprising:
determining a position for each of the plurality of ionophore-based sensor units within the first subsurface reservoir; and
mapping the local concentration values obtained from the plurality of ionophore-based sensor units to the positions within the first subsurface reservoir.

16. The method of claim 11, comprising predicting, using a machine learning algorithm, lithium concentration data for a second subsurface reservoir based on the local concentration values obtained from the plurality of ionophore-based sensor units.
